(19) United States
(12) Patent Application Publication
(10) Pub. No.: US 2018/0015668 A1
(43) Pub. Date: Jan. 18, 2018

(54) METHOD AND APPARATUS FOR THREE DIMENSIONAL PRINTING

(71) Applicant: SOMETHING3D LTD., Petah Tikva (IL)

(72) Inventors: Dotan KOSKAS, Givat Shmuel (IL); Itzhak MOLCHO, Haifa (IL)

(21) Appl. No.: 15/548,132

(22) PCT Filed: Jul. 7, 2016
(86) PCT No.: PCT/IL2016/050725

§ 371 Date: Aug. 2, 2017

Related U.S. Application Data
(60) Provisional application No. 62/190,377, filed on Jul. 9, 2015.

(51) Int. Cl. B21C 23/14; A23G 1/00; A23G 1/20

(52) U.S. Cl. CPC B29C 64/209; B29C 64/393; B21C 23/14; A23G 1/202; A23G 1/0056; B33Y 10/00; B29C 64/295; B29C 64/118; B33Y 50/02; B33Y 30/00; B29K 2995/0021

(57) ABSTRACT

A three dimensional printer extruder, comprising: a heating member comprising two or more heating member tunnels, each tunnel adapted for receiving a filament; and a nozzle comprising: a single extrusion aperture for extruding material; and two or more nozzle tunnels each connecting to one of the two or more heating member tunnels, and each having an output end at most 1.5 mm from the single extrusion aperture, wherein each filament is melted in a separate space comprising a heating member tunnel and a corresponding nozzle tunnel.

### TECHNICAL FIELD

The present disclosure relates to three-dimensional (3D) printing in general, and to an apparatus and method for high color resolution in 3D printing, in particular.

### BACKGROUND

Three-dimensional (3D) printing, also referred to as additive manufacturing (AM), relates to a number of processes for preparing a 3D object. In typical 3D printing, additive processes are used, in which successive layers of material are extruded down under computer control to form the required shape. The objects may be made in any almost any shape or geometry, and are produced from a 3D model or other electronic data source.

3D printable models may be created with a computer aided design (CAD) tool, by a 3D scanner, or by a digital camera and photogrammetry software.

The model may then undergo examination for “manifold errors”. This step is especially required for models that have been obtained through 3D scanning. Examples of manifold errors include surfaces that do not connect, gaps in the model, or the like. The manifold errors may be detected and corrected manually or by corresponding software.

The model may then undergo slicing, in which it is converted to a series of thin layers and an instruction file. The model can then be printed with 3D printing client software that loads the instructions for instructing a 3D printer during the 3D printing process. In some embodiments, the client software and the slicer are often combined into one software program.

The 3D printer follows the instructions to extrude successive layers of liquid, powder, paper or sheet material to build the model from a series of cross sections. Materials such as plastic, sand, metal, or even chocolate can be used through a printing nozzle. These layers, which correspond to the virtual cross sections from the CAD model, are joined or automatically fused to create the final shape.

In some embodiments, printable polymers allow the surface finish to be smoothed and improved using chemical vapour processes.

Printer resolution consists of layer thickness and X-Y resolution in dots per inch (dpi) or micrometers (μm).

In some embodiments, a slightly oversized version of the desired object is printed in standard resolution and then a higher-resolution subtractive process is applied for removing excess material to achieve greater precision.

### BRIEF SUMMARY

The following embodiments and aspects thereof are described and illustrated in conjunction with systems, tools and methods which are meant to be exemplary and illustrative, not limiting in scope.

A first aspect of the disclosure relates to three dimensional printer extruder, comprising: a heating member comprising two or more heating member tunnels, each tunnel adapted for receiving a filament; and a nozzle comprising: a single extrusion aperture for extruding material; and two or more nozzle tunnels each connecting to one of the heating member tunnels, and each having an output end at most 1.5 mm from the single extrusion aperture, wherein each filament is melted in a separate space comprising a heating member tunnel and a corresponding nozzle tunnel. Within the printer extruder, the nozzle may further comprise a shaft. Within the printer extruder, the at least one additional tunnel optionally passes through the shaft. Within the printer extruder, the heating member tunnels optionally receive filaments of different materials. Within the printer extruder, the different materials are materials having different colors, the different colors selected from the list consisting of: cyan, magenta, yellow, black and white. Within the printer extruder, the heating member tunnels optionally receive filaments of materials having different characteristics. Within the printer extruder, the characteristics are selected from the list consisting of: electrical conductivity; magnetism; elasticity; strength; firmness; weight; viscosity; solubility in a fluid; and concentration. Within the printer extruder, different parts of an object extruded by the three dimensional printer extruder optionally have different characteristics. Within the printer extruder, an object is optionally prepared in accordance with a process controlled by a controller adapted to: select a material to be extruded as part of a layer or a sub layer of the object; move the printer extruder from a current location to a location within the object that is in an infill area, a support or an inner shell area, wherein the location is at least at a predetermined distance from the current location; extrude a predetermined amount of the material; move the printer extruder to a new location in which the material is required; extrude the material over a required area; and repeating above steps for another material.

Another aspect of the disclosure relates to a method for three dimensional printing of a model, comprising: selecting a material to be extruded as part of a layer or a sub layer of the model; moving an printer extruder of a three dimensional printer from a current location to a location within the model that is in an infill area, a support or an inner shell area, wherein the location is at least at a predetermined distance from the current location; extruding a predetermined amount of the material; moving the printer extruder of the three dimensional printer to a new location in which the material is required; extruding the material over a required area; and repeating the steps for another material. Within the method the material and the other material are optionally of different colors. Within the method the different colors are optionally selected from the list consisting of: cyan, magenta, yellow, black and white. Within the method the material and the other material optionally have different characteristics. Within the method. moving the printer extruder of the three dimensional printer to a new location is optionally done along a piecewise straight line.

Yet another aspect of the disclosure relates to an object prepared by a process comprising the steps of: selecting a material to be extruded as part of a layer or a sub layer of the object; moving a printer extruder of a three dimensional printer from a current location to a location within the object that is in an infill area or an inner shell area, wherein the location is at least in a predetermined distance from the current location; extruding a predetermined amount of the material; moving the printer extruder of the three dimensional printer to a new location that in which the material is required; extruding the material over a required area; and repeating the steps for another material.

In addition to the exemplary aspects and embodiments described above, further aspects and embodiments will become apparent by reference to the figures and by study of the following detailed description.

Yet another aspect of the disclosure relates to a three dimensional printer extruder, comprising: a fusing member comprising at least two preparation tunnels, each preparation tunnel adapted for receiving a filament; and a nozzle comprising: a single extrusion aperture for extruding material; and two or more nozzle tunnels each connecting to one of the preparation tunnels, wherein each filament is prepared in a separate space comprising a preparation tunnel and a corresponding nozzle tunnel, and wherein the preparation tunnels receive filaments of different materials. Within the three dimensional printer extruder, the different materials optionally have different colors selected from the list consisting of: cyan, magenta, yellow, black and white. Within the three dimensional printer extruder, the different materials optionally have different characteristics selected from the list consisting of: electrical conductivity; magnetism; elasticity; strength; firmness; weight; viscosity; solubility in a fluid; and concentration. Within the three dimensional printer extruder, different parts of an object extruded by the three dimensional printer extruder optionally have different physical characteristics. Within the three dimensional printer extruder, characteristic between areas of the object extruded by the three dimensional printer optionally change gradually or abruptly. Within the three dimensional printer extruder, an object is optionally prepared by a process controlled by a controller adapted to: select a material to be extruded as part of a layer or a sub layer of the model; move the printer extruder from a current location to a location within the model that is in an infill area, a support or an inner shell area, wherein the location is at least at a predetermined distance from the current location; extrude a predetermined amount of the material; move the printer extruder to a new location in which the material is required; extrude the material over a required area; and repeat above steps for another material.

### BRIEF DESCRIPTION OF THE SEVERAL VIEWS OF THE DRAWINGS

Exemplary embodiments are illustrated in referenced figures. Dimensions of components and features shown in the figures are generally chosen for convenience and clarity of presentation and are not necessarily shown to scale. The figures are listed below.

FIGS. 1A and 1B are schematic illustrations demonstrating layer and sub layer construction, in accordance with some exemplary embodiments of the disclosure;

FIG. 2 is a schematic illustration of a ring-shaped sub-layer comprising five basic colors, and the order in which the segments are extruded, in accordance with some exemplary embodiments of the disclosure;

FIG. 3 is a flowchart of steps in a method for extruding a sub layer, in accordance with some exemplary embodiments of the disclosure;

FIGS. 4A, 4B and 4C are views of a nozzle, in accordance with some exemplary embodiments of the disclosure; and

FIG. 4D is a schematic view of a heating member, in accordance with some exemplary embodiments of the disclosure.

### DETAILED DESCRIPTION

The disclosure relates to three-dimensional (3D) printing, also referred to as additive manufacturing (AM), in which successive layers of material are extruded under computer control to form the required shape.

The printer resolution expresses the layer thickness (Z dimension) and the X-Y resolution in dots per inch (dpi) or micrometers (μm).

Some 3D printers and techniques are capable of using multiple materials in the course of constructing parts, thus enabling to print in multiple colors and color combinations, such that the finished product does not necessarily require painting. However, currently available printers and techniques do not provide for switching color within a layer, or at least not with sufficiently high color resolution. This eliminates for example the formation of fine patterns in which the colors change over a surface.

In order to provide color printing, filaments of different colors are supplied to the printer. For example, filaments of the five basic colors: cyan, magenta, yellow, black and white (CYMBW) may be used.

In traditional 3D printing methods, in order to achieve various colors and hues, also referred to as textures, the amounts of the basic colors required for printing each area of a particular color are determined. Then filaments of the basic colors in the correct proportions are fed into a hot end chamber there the filaments are fused and mixed, creating the new color. However, the mixture does not come out in a uniform color, rather the color output by the nozzle changes gradually. Thus this method does not enable instant change of the printed color while printing in accordance with the desired pattern.

Another traditional method relates to pre-processing the filament coloring: in this method the filament is being colored, or a CMYBW is being inserted to a pre-process device, thus creating a color segmented filament according to the desired texture. However, the hot end chamber does not enable rapid color change in the final printed layer.

A 3D model may generally comprise: an outer shell, which is the representative view that may comprise the pattern; an inner shell which is viewable by a person looking at the finished model from at least one direction, but does not comprise a designed face of the model, for example the inner surface of a container such as a jar; infill which is a hidden area of a model not viewable from the outside, and a support area printed for supporting the model, but is not part of the object and is later removed.

Although the disclosure below mainly relates to color, and in particular to high resolution 3D color printing, it will be appreciated that the disclosure is not limited to colors but is also applicable to other characteristics of the 3D model or its materials, such as the kind(s) of raw material, any characteristic of the raw material such as weight; viscosity; solubility in water, alcohol or the like; concentration; electrical conductivity; magnetism; elasticity; strength, firmness, or others. Thus, the disclosure relates to creating multi material objects as well.

It will also be appreciated that although the discussion below relates to five basic colors being cyan, magenta, yellow, black and white, the disclosure is not limited to any number of colors or characteristics, and any other color scheme or material combination, of any number of components, may be used.

In the discussion below, the terms voxel and pixel are used interchangeably and relate to a minimal unit having a specific color or material. The material may be extruded over an area of a pixel, such that the volume of the extruded material forms a voxel.

The disclosure below relates to creating each voxel from a predetermined number of sub-layers of filaments of the basic colors or basic materials, such that the voxel resulting from the layer combination has the required color, material combination of colors and/or materials, or properties. For example, if a voxel height is 250 micron, the voxel may be created by extruding five sub-layers of 50 micron height each, wherein each such sub-layer is of one of the basic colors or basic materials. Due to the small heights, the sequence of sub-layers appears as a voxel of the required color or material, and may have required properties. For example, in order to create a green voxel, sub-layers of cyan and yellow filaments may be used, wherein one sub-layer of cyan and four sub-layers of yellow may be used for light green, and four sub-layers of cyan and one sub-layer of yellow will produce a darker green. Thus, when some voxels of an object are made of materials other from other voxels, the resulting object is multi-material and parts of it may have properties or characteristics different from other parts.

It will be appreciated that the number of sub layers may depend on the available printing resolution. Thus, if a sub-layer of height 25 micron may be formed, then up to ten sub-layers of basic colors or materials may be extruded for each pixel, providing for higher color precision. However, fewer sub-layers may also be used.

For creating each layer, the nozzle creates the predetermined number of sub-layers, wherein during the extrusion of each such sub layer, one or more of the basic colors are output by the nozzle in accordance with the design of the sub layer. Thus, areas of the sub layer having the same basic color will be extruded consecutively, before switching to another basic color, to avoid unnecessary color switching.

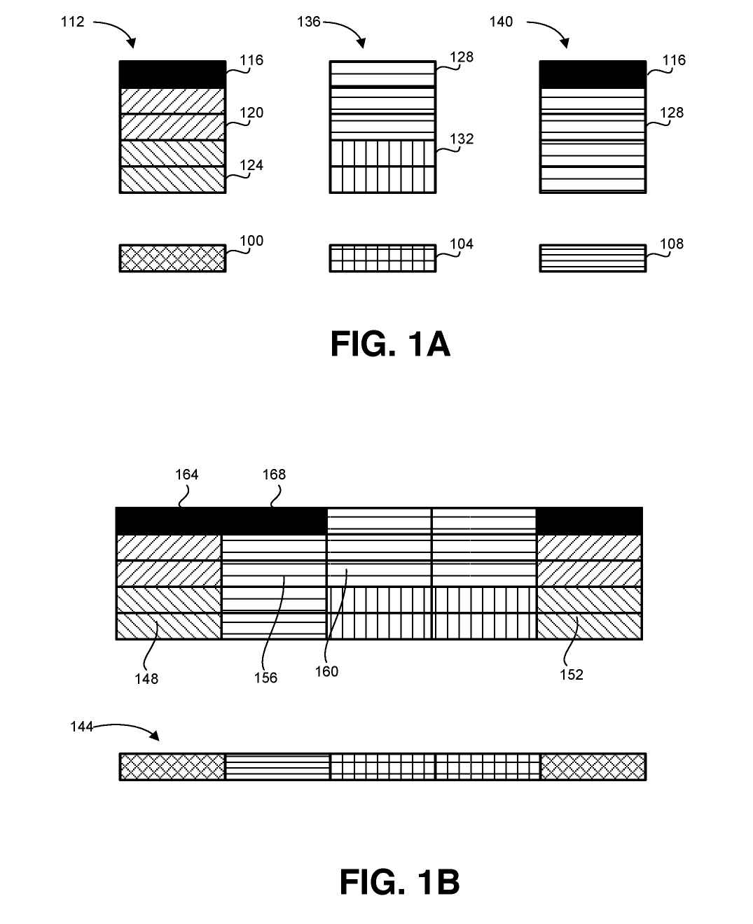

Referring now to FIGS. 1A and 1B, demonstrating the layer and sub layer construction process.

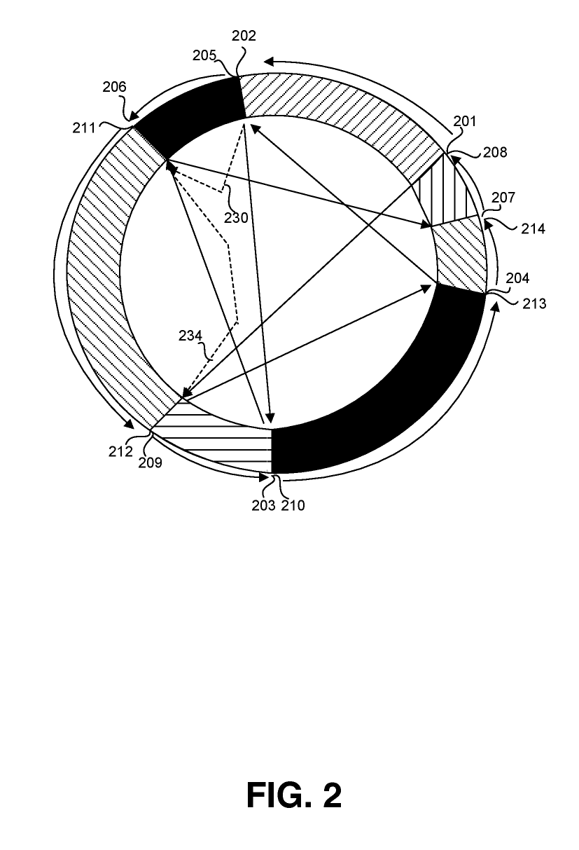

It will be appreciated that the different patterns in FIGS. 1A, 1B and 2 represent different colors. Patterns 116, 120 124, 128 and 132 represent basic colors for which filaments are available, and patterns 100, 104 and 108 represent other colors, created by combining two or more basic colors.

Color 100 is produced by combination 112, consisting of one sub-layer of basic color 116, two sub layers of basic color 120 and two sub layers of basic color 120. Color 104 is produced by combination 136, consisting of three sub layers of basic color 128 and two sub layers of basic color 132. Color 108 is produced by combination 140, consisting of one sub layer of basic color 116, and four sub layers of basic color 128.

It will be appreciated that a table or another data structure may be determined which indicates for each of a multiplicity of colors the sub layer combination of basic colors, including the different basic colors, their percentage and the relative order which provides the required color. When it is required to extrude a segment having a new color, the closest color for which such combination is available may be searched. If no entry exists for a color that is similar enough to the required color, then a combination creating the new color may be determined. Alternatively, a basic color scheme may be determined for any new color. Distance between colors may be determined, for example, by summing the absolute values of the differences in percents over the basic colors. If two colors are at the same distance from a required colors one of them may be selected arbitrarily, such as the lighter one.

FIG. 1B illustrates extruding a sequence 144 of segments having colors 100, 108, 104, 104 and 100. The sequence is formed by five sub layers, wherein the colors in the sub layers of each segment form the required color.

Each of the first and second sub layers thus consist of a segment of basic color 124, a segment of basic color 128, two segments of basic color 132 and another segment of basic color 124.

The third and fourth sublayers consist of one segment of basic color 120, three segments of basic color 128 and another segment of basic color 120. It will be appreciated that areas 156 and 160 both of basic color 128 are extruded consecutively although they participate in generating different pixel colors.

The fifth sub layer consists of two segments 164 and 168 of basic color 116, each participating in generating a different color, two segments of basic color 128 and another segment of basic color 116.

It will be appreciated that if a sub layer comprises two or more non-consecutive areas of the same basic color, these areas will be extruded one after the other without switching to another color in between, to avoid excess switching. Thus, when extruding the first sub layer shown in FIG. 1B, segments 148 and 152 will be extruded consecutively although they are not adjacent to each other.

Referring now to FIG. 2, showing an exemplary ring-shaped sub layer comprising segments of the five basic colors, and the order in which the segments are extruded. For simplicity, it is assumed that the width of the ring is one pixel.

Extruding the sub layer starts at point 201 and advances to point 202 while extruding basic color 120.

Then laying moves to point 203 and the color is switched to basic color 116. It will be appreciated that extruding material does not continue at point 202 although the segment starting at point 202 is of the same color as the segment starting at point 203, since the material the previous basic color extruded at point 202 of has just been extruded and has not dried yet. Therefore, immediately extruding a different color adjacent to it will cause some mixing, which will blur the borderline and reduce the color separation. Moving to another area avoids extruding extra material on the same location, thus providing for color separation, when extrusion will later continue at this area, indicated as point 205, the different basic colors will not mix.

From point 203 extruding continues to point 204 and then moves to point 205 and continues from there to point 206.

The used color is then changed to basic color 132 and extruding continues until point 208. The color is then switched again to basic color 128 and extruding moves to point 209 and continues to point 210.

The color is then switched to the last color, being basic color 124, and extruding starts at point 211 and continues to point 212, and then moves again to point 213 and continues to 214, completing the ring.

Thus, when it is required to change the basic color, extruding moves to a different area to let the freshly extruded material of the previous color dry.

Different areas of the same basic color may be extruded sequentially by moving from each such area to another one, such that switching to each basic color or material is done at most once during the extrusion of each sub-layer.

However, when changing the basic color or material, the tunnel containing the next color or material or the printer parts near the extrusion aperture may still contain a residual amount of the filament of the previous color, thus blurring the color distinction and preventing the printer from creating high resolution prints, or prints with detailed patterns.

In order to avoid this effect, the printer may be adapted, for example by programming, to extrude the initial amount of filament of any new color used, in a non-visible area of the sub layer, such as the infill, support, or if necessary the inner shell. Thus no material is wasted since the extruded material is used as part of the model, but since it is an area invisible under regular use, the color impurity and blurring is not a problem. After extruding the initial amount at such area, extrusion may continue as planned in areas of the sub layer with the new color, such that new color is extruded without residues of the previous color or material.

It will be appreciated that the printer head is not limited to moving between locations in straight lines, and may move using any other paths, such as “V” path 230 between locations 205 and 206, or “U” path 234 between locations 211 and 212. It will be further appreciated that any other path may be used, and the disclosure is not limited to straight lines or to piecewise straight segments.

It will be appreciated that whenever extrusion moves to another area, either for extruding an undesired mixed color filament, or for extruding at a distant area with a required color, extruding should move by at least a predetermined distance, such as about 5 mm, in order to avoid extruding extra material on the same location, and providing for color separation and avoiding the contamination of a color by another color.

Thus, the following rules may be used when planning a design:

The outer shell, including top and bottom layers and skinning] are to be extruded with the basic colors as determined for each sub layer, for creating the correct voxel color.

The initial quantity after replacing to a different color is used in the infill or support, and if impossible then in the inner shell.

Other areas of the infill, inner shell, support, brim and raft may be printed in any desired color, for example white or another default color.

During extrusion of each sub layer, when using a new color extrusion should move at least a predetermined distance away, for example about 5 mm.

Optionally, if one of the basic colors is not needed in a layer, then one sub-layer may be omitted. For example, instead of creating five sub-layers, the voxels may be created from four sub-layers.

The top and bottom layers may be printed as described below, by extruding basic colors creating each sub layer, and not along diagonal lines as is done in existing techniques.

It will be appreciated that the top, bottom and other layers may have different color ordering depending on the color needed. For example, three sub-layers of magenta and two sub-layers of black will produce different colors depending on the order of the sub-layers. Thus, the same sub-layers may be applied in different order when creating voxels at different locations. It will be appreciated that the exact order may be more significant in layers such as the top or the bottom, in which the lower sub-layers are only visible through the top layer, than in side layers in which all sub-layers are all seen from the side.

It will be appreciated that a design plan may also refer to the required properties of the product. or parts thereof. For example, some parts of the design, such as parts or all of the inner shell or the outer shell, may be reinforced by using for at least some layers of some voxels therein a filament comprising carbon fibers, glass fibers or another strengthening material, thus strengthening the structure of the printed object. Additionally or alternatively, some parts may be made more elastic than others.

It will also be appreciated that the design may comprise gradual changes of one or more colors or properties. For example, a design may comprise a sudden or gradual change in elasticity, magnetism, strength, firmness, or the like. A gradual change may be obtained by gradually changing the concentration, for example the number of layers or density of voxels having layers of materials with the required property, such as elasticity, magnetism, color or the like. Sudden or gradual change may also be obtained by replacing the materials used for materials having higher or lower values of the required property.

In another example, part or the entire product may be made to be electrically conductive by using an electrically conductive filament combined with the main filament. In some embodiments, a sequence of electrically conductive voxels may be created within the product, thus providing electrical conductivity as required. Such design may be useful, for example, for creating a lighting device or another electrical device without or with minimal wiring.

It will also be appreciated that the disclosed subject matter can be used for constructing four dimensional (4D) structures, in which one or more volume elements may change their properties in response to external conditions, such as temperature, radiation, humidity, or the like. Using such materials, an element may be created which may assume its required properties at a later time, for example when installed at its required location. The required properties can vary between different parts of the product, for example external parts of a building may be made stronger than internal parts either by using stronger materials or by using materials that may become stronger under radiation or another condition.

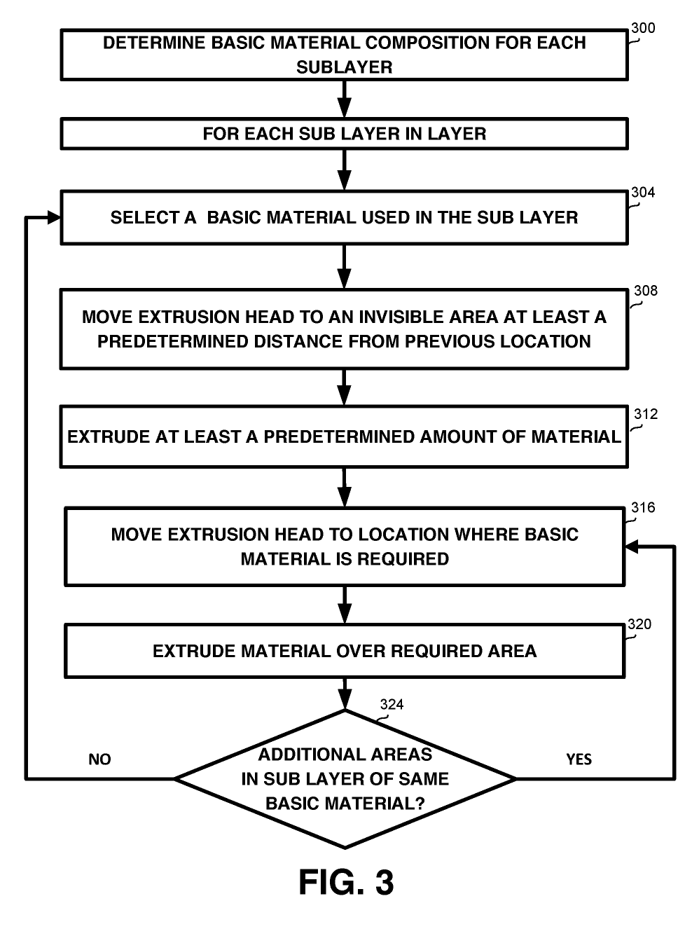

Referring now to FIG. 3 showing a flowchart of steps in a method for laying a sub layer.

Although the method of FIG. 3 relates to color printing, it will be appreciated that the method is not limited to printing in multiple colors, and may be used for high resolution printing with different materials, or materials having different characteristics or properties, such as electrical conductivity, magnetism, strength, firmness, texture, solubility, or the like. In some cases, there may not be a need for extruding sub layers, and voxels of a layer may be extruded as a single layer. In such cases step 30 below may be ignored and the steps may be applied to a layer rather than to a sub layer.

On step 300 the basic color or material composition required for each sub layer is determined. It will be appreciated that the determination may be done at once for all sub layers of a particular layer. Further, the basic color or material composition may be determined a priori for the whole model or parts thereof. The determination may be done on a per-voxel basis, wherein each voxel may be comprised of a predetermined number of sub layers that together appear to the eye as the required color or have the required properties or characteristics.

The following steps are performed for each such sub layer in one or more layers of the model.

On step 304, a basic filament used in the sub layer is selected. The basic filament may be selected arbitrarily from the basic filament that have not been extruded yet for the sub layer, or in accordance with other considerations such as drying time, voxel structure, or the like. In some embodiments, the basic filaments may be extruded in a constant order. For example, if the basic filaments are of different colors, then they may be extruded in the following order: white, cyan, magenta, yellow and black.

On step 308 the printer extruder is moved to an invisible area of the model, such as infill, support or inner shell. The printer extruder is to be moved at least by a predetermined distance, such as at least about 5 mm.

On step 312, at least a predetermined amount of material is extruded at the location. The extruded amount is such that the amount collected in the gap between the tip ends and the extrusion aperture, as well as the amount of the previous filament diffused into the tunnel of the selected filament are all extruded. It will be appreciated that the material may be extruded while the nozzle is moving, such that an area is covered.

Step 308 and 312 may be omitted for the first filament of a first sub layer of a model, or in other circumstances in which no previous filament was used, and no residuals were left in the gap between the tip end and the extrusion aperture or in the tip.

On step 316, the printer extruder is moved to an area of the model in which the selected basic filament is required.

On step 320, the material, such as the heated filament of the selected material, is extruded over the area in which the material is required.

On step 324 it may be determined whether there are additional areas of the sub layer in which the particular basic material is required. If there is such area, execution goes back to step 316 and extrusion continues for the area. Otherwise execution goes back to step 304 in which another basic material is selected, until all basic material are extruded for the sub layer.

Execution may then continue to the next sub layer, and once the layer is finished, to the next layer.

It will be appreciated that the method of FIG. 3 is not limited to printing in multiple colors, and may be used for high resolution printing with different materials or materials having different characteristics to extrude new materials and/or new composite materials. In some cases, there may not be a need for extruding sub layers, and voxels of a layer may be extruded as a single layer.

The method of Claim 3 may be controlled by a controller or a processor, such as a Central Processing Unit (CPU), a microprocessor, an electronic circuit, an Integrated Circuit (IC), a Central Processor (CP), or the like. The controller may be adapted to control the extruder and perform the steps described above.

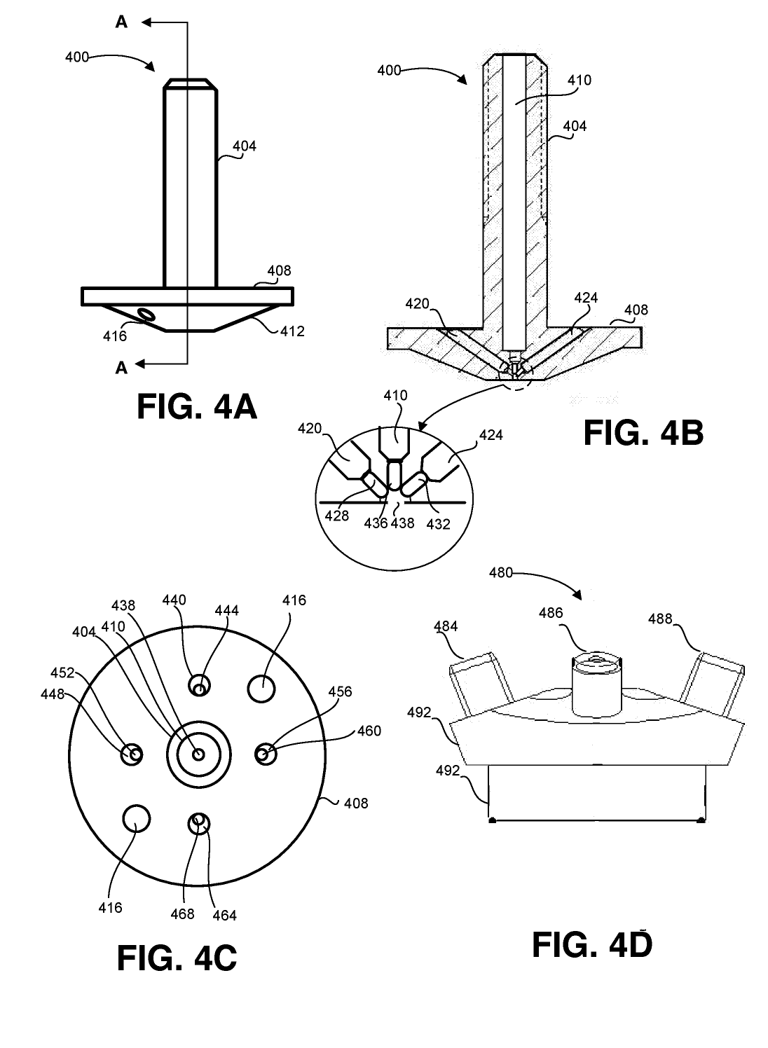

Referring now to FIGS. 4A-4D, showing members of a three dimensional printer extruder in accordance with the disclosure, the printer extruder comprising a heating member and a nozzle.

Referring now to FIGS. 4A, 4B and 4C, showing views of a nozzle in accordance with some embodiments.

In typical printing devices, each filament may be wound around a cylinder and unreeled to supply material to the extrusion nozzle. A heating member heats the material and turns the flow on and off. Typically a stepper motor or a servo motor is employed to move to adjust the flow of each of the filaments.

In some embodiments of the disclosure, in order to create a voxel of a particular color by laying sub-layers of basic colors, a nozzle may be used, which is fed by any number, for example five, of filaments, and has a single extrusion aperture, extruding material of one basic color at a time. Each filament may be received through a nozzle tunnel within the nozzle, and all nozzle tunnels end as close as possible to the single extrusion aperture of the nozzle.

Having a single extrusion aperture avoids the dripping or otherwise staining of a one or more previously used colors, which may stain the design and inhibit high resolution patterns. The single extrusion aperture is also easier to manufacture and maintain.

A nozzle in accordance with the disclosure melts and outputs filament of a single basic color at a time and does not mix colors, excluding residual quantities. In order to reduce as much as possible the pool of residual material of the extruded filament that may remain in the gap between the nozzle tunnel ends and the extrusion aperture, and that may mix with the next extruded filament, the distance between the nozzle tunnel ends and the extrusion aperture of the nozzle is made as small as possible, for example up to 0.5 mm, up to 1 mm, up to 1.5 mm, or the like, depending on the available production precision and tolerance. It will be appreciated, however, that the distance between the nozzle tunnel ends and the extrusion aperture may also depend on the application and its size. For example, when creating large objects such as a wall, the distance can be as large as 100 mm or more. Thus, the nozzle does not contain a mixing chamber and does not mix filaments of different basic colors for obtaining a particular color, but rather creates the color of the voxel by extruding separate sub layers of basic colors wherein the basic color combination, including the percentage of each color and the order form the required color.

FIG. 4A shows a side view of a nozzle in accordance with the disclosure. The nozzle, generally referenced 400, may comprise a main shaft 404 which may connect the nozzle to the printer, contain wires for supplying power or other utilities from the printer to the nozzle, or transferring data to and from the nozzle.

In some embodiments, one filament, for example a white filament may also be supplied through a tunnel (not shown) going along the long cross section of shaft 404.

Nozzle 400 may further comprise cover 408 which comprises further segments of the nozzle tunnels, and body 412 having within other segments of the nozzle tunnel for the filaments, and the extrusion aperture. Main body 412 may connect to cover 408 by one or more screws 416.

Referring now to FIG. 4B, showing a cross section along the line A-A of FIG. 4A.

FIG. 4B shows nozzle tunnel 410 of nozzle 400, which may supply one filament, such as a white filament when the CMYBW scheme is used. However, the disclosure is not limited to nozzles having a nozzle tunnel along the main shaft, and such tube may be omitted.

Cover 408 and main body 412 may comprise corresponding nozzle tunnel segments that form together nozzle tunnel for the other filaments, such as input nozzle tunnels 420 and 424. Similarly, two other nozzle tunnels may be seen in a cross section perpendicular to the cross section of FIG. 4B.

However, it will be appreciated that the disclosure is not limited to any number of filaments, and any number other than four (five including the nozzle tunnel along the main shaft) may also be used.

Each nozzle tunnel may end with a narrow tip, such as tip 428 of nozzle tunnels 420, tip 432 of nozzle tunnels 424, and tip 436 of nozzle tunnels 410. However, the tips are not mandatory and other designs in which the nozzle tunnels have their output ends at close proximity to extrusion aperture 438 may be used.

The nozzle tunnel and tip ends are positioned such that the tip ends are as close as possible to extrusion aperture 438 through which the material is extruded, so as to minimize the gap between the tip ends and the aperture, thus reducing the amount of residual material that is to be extruded in an invisible area to avoid color blurring.

Referring now to FIG. 4C, showing a top view of nozzle 400. Cover 408 has thereon shaft 404 having within nozzle tunnel 410 for one filament 439.

The other filaments 444, 452, 460 and 468 may be fed to the nozzle through openings 440, 448, 456 and 464, respectively.

Openings 416 may be used for screws connecting cover 408 and main body 412.

It will be appreciated that nozzle 400 may comprise additional components, such as a one or more motors for advancing each filament through the heating member tunnel described below and corresponding nozzle tunnel to its output end where it is heated or otherwise melted, by a heating member or a melting member, and flows out through the extrusion aperture.

Referring now to FIG. 4D, showing a side view of heating member 480. Heating member 480 has a heating member 492, made for example of brass, to which nozzle 400 connects, by inserting shaft 404 into a corresponding space (not shown) in heating member 480, with or without screwing. After insertion, nozzle 400 is located below heating member 480. It will be appreciated that heating member 492 may comprise multiple parts, depending on the specific design. Heating member 480 may comprise a multiplicity, such as four, side cylinders 484, 486 and 488, and may also comprise a further cylinder (not shown), which may be located in the center of heating member 480. Each cylinder may have an internal heating tunnel therein, such that when heating member 480 connects to nozzle 400, each heating tunnel of heating member 480 connects to one of the nozzle tunnels of nozzle 400, such as tunnels 420, 424, or others or to tunnel 410. A roller of filament may be placed on any cylinder 484 or on the additional cylinder.

Heating member 480 heats the filament in the tunnels therein and in the tunnels of nozzle 400. However, heating member 480 and nozzle 400 are designed such that each filament is heated and melted in a separate chamber such that the melted filaments do not mix. When one filament is extruded due to activation of its corresponding engine, the filament pours out of aperture 438, and blocks the other filaments from pouring out. Thus, nozzle 400 and heating member 480 extrude one filament at a time, wherein the filament is melted in a separate space comprising a heating member tunnel a corresponding nozzle tunnel. Due to the small distance between the tunnels opening and the aperture, there is no chamber common to a multiplicity of filaments and no mixing of filament occurs. Thus, nozzle 400 and heating member 480 may provide for extruding separate basic colors, such as cyan, magenta, yellow, black and white. When the system is used for creating multi-material models, selected filaments can be different kinds of materials such as grades of flex ABS or grades of conductive materials.

It will be appreciated that although the disclosure above mainly relates to high resolutions and relatively small objects, this is not a limitation, and the disclosure is applicable also to objects of any size, wherein the resolution and the voxel size may vary accordingly, for example the voxel size may be larger, smaller or variable as required. For example, objects of large size such as walls or other structures, vehicle or vehicle parts may be manufactured, using a three dimensional printer extruder and method in accordance with the disclosure. Such objects may also benefit from different properties or characteristics assigned to different parts of the printed structures, such as different strength, firmness, electrical conductivity, or the like. For example, a wall may be manufacture using a three dimensional printer as described, wherein different colors applied to different areas of the wall, thus creating a built-in wall painting. In other applications, by embedding electrical conductive material in voxels of the wall along a line, conductive lines may be formed internally to a wall which may replace pipes through which wires may be threaded.

Manufacturing such objects may require preparing the materials in a different manner than heating. Thus, an extruder in accordance with the disclosure may comprise a fusing member comprising two or more preparation tunnels, each adapted for receiving a filament, and a nozzle comprising an extrusion aperture for extruding material; and two or more nozzle tunnels each connecting to one of the preparation tunnels, wherein each filament is prepared in a separate space comprising a preparation tunnel and a corresponding nozzle tunnel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise” “include” and “have”, and forms thereof, are not necessarily limited to members in a list with which the words may be associated. In addition, where there are inconsistencies between this application and any document incorporated by reference.

As will be appreciated by one skilled in the art, the disclosed subject matter may be embodied as a system, method or a product comprising a computer program.

Computer program code for carrying out operations of the present invention may be written in any combination of one or more programming languages, including an object oriented programming language such as Java, C#, C++ or the like and conventional procedural programming languages, such as the “C”, assembly programming language or similar programming languages. The program code may execute entirely on any of the devices or on an external device or system.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A three dimensional printer extruder, comprising:
a heating member comprising at least two heating member tunnels, each tunnel adapted for receiving a filament;
a nozzle comprising:
a single extrusion aperture for extruding material; and
at least two nozzle tunnels each connecting to one of the at least two heating member tunnels, and each having an output end at most 1.5 mm from the single extrusion aperture,
wherein each filament is melted in a separate space comprising a heating member tunnel and a corresponding nozzle tunnel; and
a processor for controlling the heating member and the nozzle, wherein the processor is configured to:
a. determine a sub-layer combination for creating at least one voxel of the model having required characteristic, the sub-layer combination comprising a predetermined number of sub-layers;
b. select a material to be extruded for a first sub layer of the sub-layer combination;
c. move a printer extruder of a three dimensional printer to a location within the model that is in an infill area, a support or an inner shell area;
d. extrude a predetermined amount of the material;
e. move the printer extruder of the three dimensional printer to a location of the at least one voxel;
f. extrude the material over a required area to form the first sub layer of the at least one voxel; and
g. repeat steps (b) to (f) for another material for forming a subsequent sub-layer from the sub-layer combination.

2. (canceled)

3. (canceled)

4. The printer extruder of claim 1, wherein the at least two heating member tunnels receive filaments of different colors.

5. The printer extruder of claim 1, wherein the sub-layer combination is determined in accordance with a table indicating sub layer combinations and relative order for each of a multiplicity of colors.

6. The printer extruder of claim 1, wherein the at least two heating member tunnels receive filaments of materials having different characteristics.

7. The printer extruder of claim 6, wherein the characteristics are selected from the list consisting of: electrical conductivity; magnetism; elasticity; strength; firmness; weight; viscosity; solubility in a fluid; and concentration.

8. (canceled)

9. (canceled)

10. A method for three dimensional printing of a model, comprising:
a. determining a sub-layer combination for creating at least one voxel of the model having required characteristic, the sub-layer combination comprising a predetermined number of sub-layers;
b. selecting a material to be extruded for a first sub layer of the sub-layer combination;
c. moving a printer extruder of a three dimensional printer to a location within the model that is in an infill area, a support or an inner shell area;
d. extruding a predetermined amount of the material;
e. moving the printer extruder of the three dimensional printer to a location of the at least one voxel;
f. extruding the material over a required area to form the first sub layer of the at least one voxel; and
g. repeating steps (b) to (f) for another material for forming a subsequent sub-layer from the sub-layer combination.

11. The method of claim 10, wherein the material and the another material are of different colors.

12. The method of claim 10, wherein the location within the model that is in an infill area, a support or an inner shell area is at least at a predetermined distance from a current location of the printer extruder.

13. The method of claim 10, wherein moving the printer extruder of the three dimensional printer to a new location is done along a piecewise straight line.

14. An object prepared by a process comprising the steps of:
a. determining a sub-layer combination for creating at least one voxel of the model having required characteristic, the sub-layer combination comprising a predetermined number of sub-layers;
b. selecting a material to be extruded for a first sub layer of the sub-layer combination;
c. moving a printer extruder of a three dimensional printer to a location within the object that is in an infill area or an inner shell area;
d. extruding a predetermined amount of the material;
e. moving the printer extruder of the three dimensional printer to a new location of the at least one voxel;
f. extruding the material over a required area to form the first sub layer of the at least one voxel; and
repeating steps (b) to (f) for another material, for forming a subsequent sub-layer from the sub-layer combination.

15. (canceled)

16. (canceled)

17. (canceled)

18. (canceled)

19. (canceled)

20. (canceled)

21. The method of claim 10, wherein the required characteristic of the voxel is a color.

22. The method of claim 11, wherein the sub-layer combination is determined in accordance with a table indicating sub layer combinations and relative order for each of a multiplicity of colors.

23. The method of claim 10, wherein the required characteristic of the voxel is selected from the list consisting of: electrical conductivity; magnetism; elasticity; strength; firmness; weight; viscosity; solubility in a fluid; and concentration.

24. The method of claim 10, wherein the sub-layer combination is pre-determined for a multiplicity of voxels of the model.

25. The object of claim 14, wherein the sub-layer combination is determined in accordance with a table indicating sub layer combinations and relative order for each of a multiplicity of colors.
